(19) United States
(12) Patent Application Publication
(10) Pub. No.: US 2006/0193514 A1
(43) Pub. Date: Aug. 31, 2006

(54) Image for compression and transport of active graphical images

(75) Inventor: Kasturi A. I. Munasinghe, London (GB)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Method For Compression And Trasport Of Active Graphical Images Electrosonic Limited Corporation

(21) Appl. No.: 10/535,901

(22) PCT Filed: Nov. 19, 2003
(86) PCT No.: PCT/GB03/05043

§ 371 Date: Mar. 23, 2006

(30) Foreign Application Priority Data
Nov. 22, 2002 (GB) 0227329.0

(51) Int. Cl. G06K 9/00; G06K 9/36

(52) U.S. Cl. 382/166; 382/232

(57) ABSTRACT

A method of compressing an image comprises dividing the image into a plurality of scan paths, each path comprising pixels having the same or a similar colour. The position and shape of each scan path, together with the colour, are encoded and transmitted in a lossless compressed format, such that the entire image can recreated at a receiving end by a decoding process. The method finds particular application in active graphics systems, wherein each encoded image is an XOR combination of two sequential images, such that, from an initial image and a set of such encoded “combination” images, the second and subsequent images can be recreated.

The present invention relates to image compression and is particularly concerned with arrangements which enable images in the form of an array of pixels to be scanned in such a way that permits efficient compression, transport and decompression of the resulting image signal.

The invention also relates to the scanning of images which are created from two sequential images by combining a binary digital representation of each pixel using a bitwise or pixelwise Exclusive OR function, referred to herein an XOR function. By combining the binary digital representation of the pixels of the first image in a sequence with the XOR function of the first and second images, a digital representation of the pixels of the second image is produced. Such an XOR function is highly advantageous when compressing images, e.g. for transmission with reduced bandwidth or for storage with reduced capacity, since many sequences of images include sub-sequences of identical images which result in XOR functions which are zero-valued for the entire image. Furthermore, even when images change, it is often the case that a significant proportion of the image remains unchanged, so that the XOR function is still zero-valued for such a large portion.

The invention finds particular application in systems for transmitting active graphics images in a lossless compressed format.

The present invention is based, at least in part, on the recognition that, images, particularly graphic or photographic images, often exhibit regions of the same visual characteristic, such as colour or luminosity. In addition, such images often exhibit consistent changes in visual characteristic, with the result that an XOR function of two sequential images involving such consistent changes bears the same value for certain regions of the image.

A known scanning technique is simple raster scanning in which the pixels of each horizontal line of the image are read in sequence, from left to right, before proceeding to the next line. However, whereas such scanning is acceptable for compression purposes when an image contains regions with the same visual characteristic which extend over substantial portions of the horizontal lines of the scanned image, or when an XOR function is created between two sequential images which are identical, or when there are consistent changes between two sequential images which occur over substantial portions of the horizontal lines.

Another known scanning technique uses a predetermined space-filling curve, such as a Hilbert curve, which can be expressed mathematically by a formula and which is a “self-similar” or fractal curve. Such a curve exhibits the property that it passes through each pixel within the entire image exactly once and in such a way that local two-dimensional regions are completely scanned before passing on to adjacent region. This scanning technique provides the advantage that it more readily enables efficient compressing of either images containing two-dimensional regions in which the pixels have the same visual characteristic or XOR functions of two sequential images within a sequence in which consistent changes occur within two-dimensional regions. Since the scanning is effectively two-dimensional, greater compression efficiency is achieved.

However, such a scanning technique suffers the disadvantage that the scanning curve is pre-determiined and cannot therefore take maximum advantage of two-dimensional regions within the image which include pixels having identical characteristics.

A further known scanning technique involves the use of a context-based space-filling curve which passes through each pixel of the entire image only once but which is not based on a mathematical formula but rather depends on the characteristics of the individual pixels of the image. Thus, small squares within the image are sequentially scanned according to a weight function or similar colour. However, the derivation of the scan line in such a technique is time-consuming, and efficient compression is still not guaranteed. Details of this technique are described in “Context-based Space Filling Curves” by Revital Dafner, Daniel Cohen-Or and Yossi Matias, EUROGRAPHICS '2000, Volume 19 (2000) No. 5.

It would therefore be desirable to provide a scanning technique which seeks to overcome, or at least mitigate, one or more of the above disadvantages of the above known techniques.

Thus, in accordance with the present invention there is provided a method of compressing an image containing an array of pixels, each pixel having a given value for a visual parameter, the method comprising dividing the image into a plurality of scan paths, each path comprising a sequence of adjacent pixels, the value of the visual parameter of each pixel bearing a predetermined relationship with that of the preceding pixel in the sequence.

Such a method provides the advantage that each scan path is autocorrelated and the pixel information within this scan path can therefore be efficiently compressed.

The predetermined relationship may comprise an identity of parameter values or a similarity therebetween.

If the parameter values are identical, then this further aids efficient compression, and, if similarity is permitted, then this reduces the number of scan paths required to cover the entire image.

Each scan path is preferably determined by (a) identifying the first pixel along a linear scan of the pixel array which does not form part of a previously determined scan path; (b) identifying the value of the visual parameter of the first pixel; (c) selecting as the next pixel for the scan path one of the nearest-neighbour pixels provided that both (I) the nearest-neighbour pixel does not form one of a previously determined scan path and (II) the value of the visual parameter of the nearest-neighbour pixel bears said predetermined relationship with that of the preceding pixel; and (d) repeating step (c) until no further nearest-neighbour pixels meet both conditions (I) and (II).

If both provisos (I) and (II) are met by more than one of the nearest-neighbour pixels, then the said next pixel is preferably selected in dependence on the shape of the part of the current scan path so far determined.

The next pixel is preferably selected in accordance with an heuristic function which tends to maximise the area bounded by the scan path.

The visual parameter preferably comprises colour. However, in the case of either colour or black and white images, brightness, or luminosity, could be the parameter of choice.

The invention extends to a method of encoding an image containing an array of pixels comprising scanning the image using the above method and encoding as a digital sequence for each of said paths: (a) the position within the array of the origin of said scan path; (b) the shape of the scan path; and (c) the value of the visual parameters of the pixels within the scan path.

The position of the origin of each scan path is preferably encoded as the number of pixels along a raster scan from the previous origin of another scan path. This number can, in general, be encoded by a smaller number than can the absolute position of the pixel within the array.

The shape of the scan path is preferably encoded as a sequence of vectors, each vector within the sequence comprising a direction indicator and a length indicator. In the case of scan paths having substantial portions in the form of a straight line, this aids efficiency of compression, since a single vector can represent the entire portion.

The value of the visual parameter of each pixel is preferably encoded in accordance with a table in which a plurality of values of the visual parameter are stored at respective addresses, the visual parameter being encoded, in the case where its value is already stored in the table, by the address within the table at which the value is stored and, in the case where its value is not already stored in the table, by the value itself. The provision of such a table enables the digital representations of commonly encountered colours to be stored in the table, such that these colours can be represented in the encoded image by a smaller number, which enhances compression.

A local search is preferably performed for approximate matches. If the search is successful, the pixel is preferably encoded by the address of the approximate match and the variation from the approximate match.

In the case where the value of the visual parameter or an approximate match is not already stored in the table, the value is, subject to a replacement protocol, written into the table at an address derived from a hash function of the value. The replacement protocol is that, if there is a value already occupying the same location, it is replaced by the new value only if the usefulness of the old value, as measured by weight function, is less than a predetermined threshold. The weight function is increased for each time that the location is requested by another value. A hash function is a mathematical function which maps values of a broader domain into a smaller range and provides the advantage of speed in locating an element in a table. A common example of a hash function is a check digit or parity bit.

Each of the encoded scan paths preferably terminates with a termination marker. This serves to identify the end of each scan path and therefore aids the decoding process.

The invention further extends to a method of encoding the difference between a first and a second image by forming a third image in which each pixel is an Exclusive OR combination of the corresponding pixels of the first and second image and encoding the third image using the above encoding method.

The invention extends to a method of transmitting an image sequence comprising: (a) encoding the first image of the sequence as a bit map; (b) encoding the difference between each of the subsequent images of the sequence and its preceding image in the sequence in accordance with the above encoding method; and (c) transmitting the first image encoded as per step (a) and the differences encoded as per step (b).

The invention further extends to a method of decoding an image sequence which has been transmitted by the above transmission method, comprising the steps of: (a) decoding the first image from the bit map; (b) decoding the differences between subsequent pairs of sequential images; and (c) combining, in sequence, each decoded difference with the preceding image in the sequence thereby to recreate the subsequent images.

A preferred embodiment of the invention will now be described with reference to the accompanying drawings, in which:

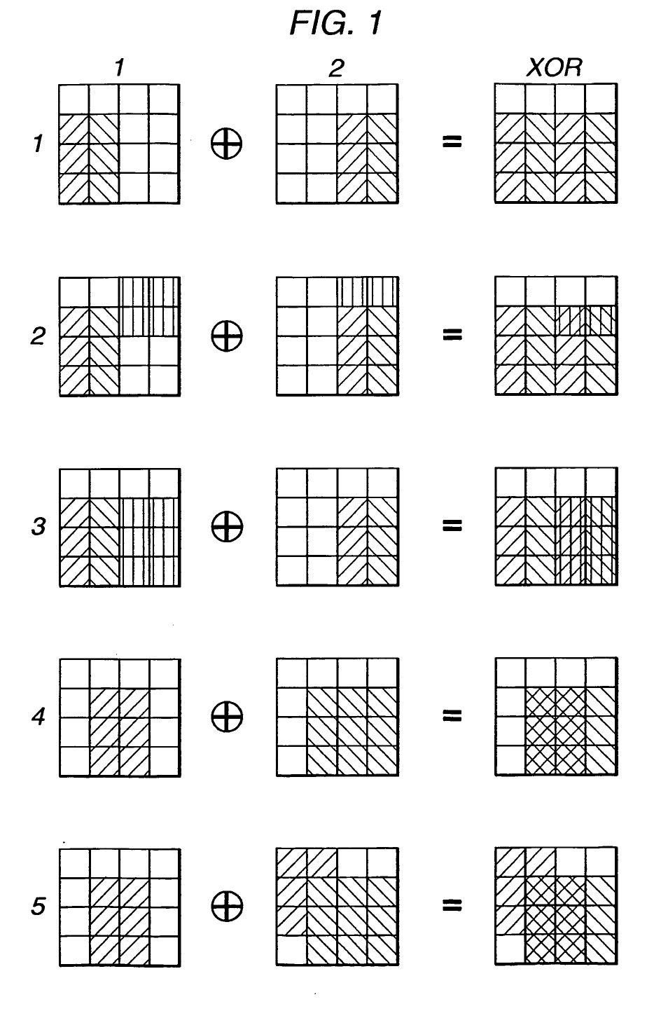

FIG. 1 illustrates the formation of an XOR function from each of five pairs of sequential graphic images;

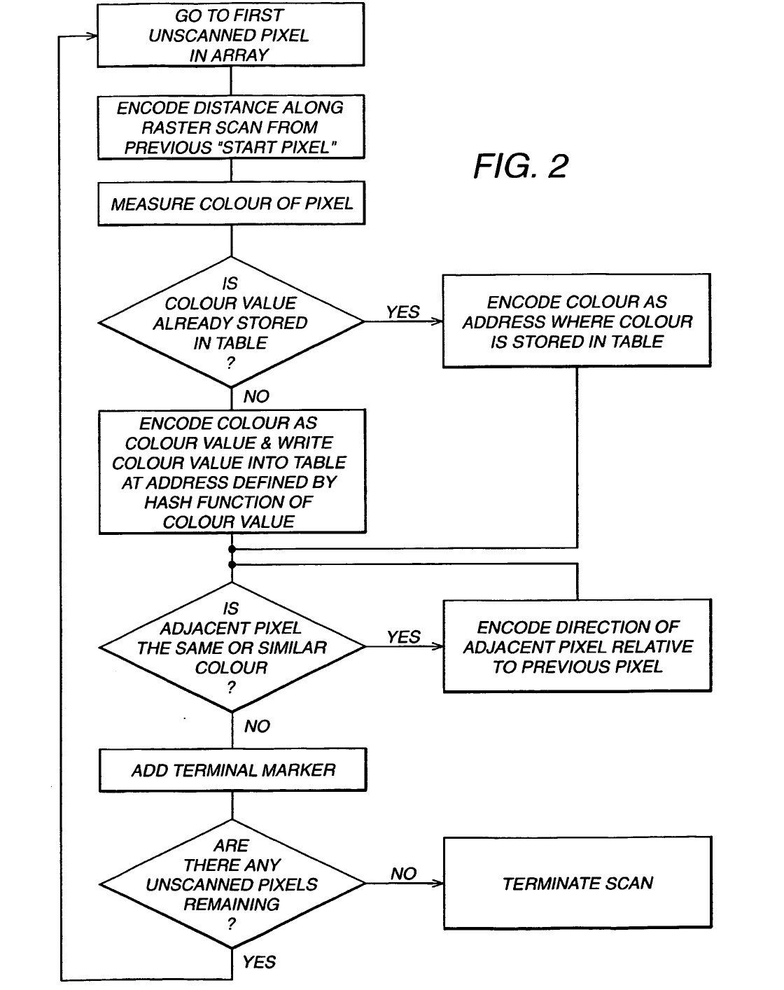

FIG. 2 is a flowchart illustrating the scanning method of a preferred embodiment of the present invention; and

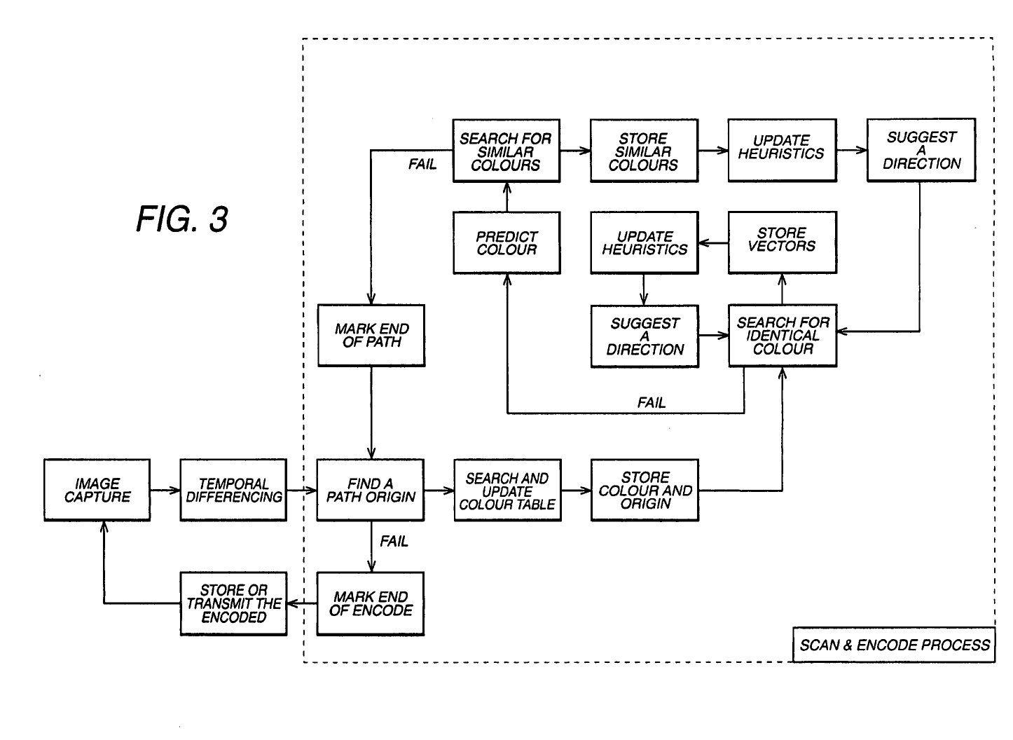

FIG. 3 is a flowchart illustrating how the scan and encode mechanism is implemented in a preferred embodiment of the present invention.

Referring to FIG. 1, five different changes within graphic images are illustrated. The shadings in the images illustrate respective colours. From the pairs of images illustrated in columns 1 and 2 may be created respective “difference images”, illustrated in the column headed “XOR”. These are created by forming, for each pixel, a bitwise XOR function of the binary digital representation of the colour of that pixel in the first image with that of the corresponding pixel in the second image. The pixels of the resulting image bear the colour associated with the binary digital representation of the XOR function.

Row 1 represents a simple horizontal displacement of a portion of a graphic image formed from two different colours. Row 2 represents the horizontal displacement of a first, two-coloured portion such that it partially obscures a second portion having a different colour. Row 3 represents the horizontal displacement of a first, two-coloured portion such that it fully obscures a second portion having a different colour. Row 4 represents the obscuration of a first, single-coloured portion by a second, larger portion having a different colour. Row 5 represents the diagonal displacement of a first, single-coloured portion of an image, combined with the partial overlap of that portion by a second portion having a different colour.

In each case, it can be seen how the resulting XOR function is highly autocorrelated, that is to say there are large regions within the resulting XOR image which have the same colour and which therefore exhibit the potential for efficient compression, provided a suitable scanning technique is employed.

Referring to FIGS. 2 and 3, the flowcharts illustrate a preferred embodiment of the scanning method. The first unscanned pixel within the array is first determined. In the case of the first scan line, this will be the first pixel in the array. The position of this pixel is encoded as the distance, in number of pixels, along a raster scan, from the first pixel of the previously encoded scan path, and the encoded value is written into an output memory. The binary digital representation of the colour of this pixel is determined, and this is compared with the e.g. 63 colour values stored in a table. If it matches any of the stored values, the colour is encoded by the address of the table at which the matching colour value is stored, and this encoded address is written into the output memory. Otherwise, the colour is encoded as the binary digital representation itself, which is written into the output memory. In this case, the digital representation is written into the table at an address defined by a hash value of the digital representation. This means that if the same colour is encountered again in a subsequent pixel within the image it can be encoded with the hash value and not the entire digital representation. Once a pixel is scanned, it is converted into a “black” pixel such that it is not scanned again.

The nearest-neighbour pixels are then considered. If none of them has the same colour, then it is determined whether any of them have a similar colour (to be defined below). If none has a similar colour, then a binary digital terminal marker is written into the output memory.

If only one of the nearest-neighbour pixels has the same colour, then the direction of this pixel in relation to the previous pixel is written into the output memory as part of a vector and the colour is encoded and written into the output memory.

If more than one of the nearest-neighbour pixels has the same colour, then a pixel is selected in accordance with a first heuristic function which depends on the previous directions taken in the same path. Again, the direction of the selected pixel in relation to the previous pixel is written into the output memory as part of a vector and the colour is encoded and written into the output memory.

If no nearest-neighbour pixels have the same colour and only one of the nearest-neighbour pixels has a similar colour, then the direction of this pixel in relation to the previous pixel is written into the output memory as part of a vector and the “similar” colour is encoded and written into the output memory.

If more than one of the nearest-neighbour pixels has a “similar” colour, then a pixel is selected in accordance with a second heuristic function which weights each direction and change of direction such that the scan path tends to remain in the locality. The reason for using this second heuristic function with similar colours is that the occurrence of similar pixels is more likely in the same neighbourhood. Again, the direction of the selected pixel in relation to the previous pixel is written into the output memory as part of a vector and the “similar” colour is encoded and written into the output memory.

This process is repeated until no nearest-neighbour pixels have the same or similar colour, and a binary digital terminal marker is written into the output memory.

The next scan line is started at the first unscanned pixel within the image, and the process repeated.

The scanning continues until no pixel within the image remains unscanned, and an “end of encoding” marker is written in the output memory. At this stage, the entire image has been divided into a number of discontinuous scan paths, each of which includes pixels having the same or a similar colour.

“Similar” colours arise in photographic images, in which neighbouring pixels often have only small differences in the red, green and blue colour components. By encoding these small differences, fewer bytes are required, resulting in enhanced compression.

In the above scanning process, if no nearest-neighbour pixels are determined to be the same as that of the previous pixel within the scan path, a determination is made as to whether is a similar colour. This is done by making a prediction of its colour based on the current colour and the previous colour encoded in the same scan path. One example of suitable prediction formulae which can be used is:
Predictionₙ=(Colourₙ+Colourₙ₋₁)/2+PredictionErrorₙ₋₁/2
PredictionErrorₙ₋₁=(Predictionₙ₋₁−Colourₙ)

The colour of the pixel under consideration is determined, and, if the prediction error is below a predetermined threshold value, e.g. the error is small enough to be encoded as 2 or 3 bytes or the size of a table address, then the colour is regarded as similar. Highest compression can be achieved by storing prediction errors in a table. As with the newly-encountered colours, a hash function of the each prediction error is used to generate the address where that prediction error is stored. On the first occasion that a prediction error is encountered within an image, the prediction error itself is added to the output memory. On subsequent occasions, however, the hash value is stored into the output memory.

The encoded valued of the image can be transmitted to a remote location during the scanning process. Alternatively, the entire encoded image can be written into the output memory and subsequently be transmitted.

At the receiving end, the encoded image is decoded using a colour table and a prediction error table which are identical to those used in the encoding process. Whenever a fill digital representation of a colour or a prediction error is encountered in the encoded image, that digital representation is stored into the table at an address defined by the same hash function employed during the encoding process. Decoding continues by recreating the scan paths from the encoded start positions, vectors, colours and prediction errors until the “end of encoding marker” is detected.

The nature of the decode process is such that less processing power is required compared to encode, making this an asymmetric system particularly suitable for a software decode process.

If the image being transmitted represents an XOR “difference” image, then the decoded image is combined, again using a bitwise XOR function, with the previous image to form the new image.

The above scanning, encoding and decoding methods are particularly, but not exclusively, applicable to systems with multiple content servers and multiple clients. Such systems require a multicasting environment in which one server (a serving node) can service multiple clients (receiving nodes). Nodes can joint the network at any time. When a receiving node is establishing a connection, it would broadcast a request to be connected to a specific serving node. The nodes receive this request, and the closest and least burdened node will send a “fresh frame” to the new receiving node and also the subsequent updates until the new receiving node “catches up” with the serving node. The new receiving node will additionally accumulate the updated images (XORed on top of each other until the sequence is complete) from the serving node if necessary. These updates and frames are identified by a unique sequence number.

It would be possible to record the active graphics on an offline medium for subsequent playback. The keystrokes and mouse clicks and movements would be stored in conjunction with the encoded image. This would be achieved by replacing the network transport layer with an offline medium reader/writer.

Although the present invention has been described by way of a specific embodiment, numerous modification and variations will be apparent to the skilled person, and the scope of the present invention is defined solely by the appended claims.

1-15. (canceled)

16. A method of compressing an image containing an array of pixels, each pixel having a given value for a visual parameter, the method comprising:
dividing the image into a plurality of scan paths, each path comprising a sequence of adjacent pixels, the value of the visual parameter of each pixel bearing a predetermined relationship with that of the preceding pixel in the sequence;
encoding as a digital sequence for each of said paths: (a) the position within the array of a first end of said scan path; (b) the shape of the scan path; and (c) the value of the visual parameters of the pixels within the scan paths; and
compressing the resulting plurality of digital sequences.

17. The method as claimed in claim 16, wherein the predetermined relationship comprises an identity of parameter values or a similarity therebetween.

18. The method as claimed in claim 16, wherein each scan path is determined by:
(a) identifying the first pixel along a linear scan of the pixel array which does not form part of a previously determined scan path;
(b) identifying the value of the visual parameter of the first pixel;
(c) selecting as the next pixel for the scan path one of the nearest-neighbor pixels provided that both (I) the nearest-neighbor pixel does not form one of a previously determined scan path and (II) the value of the visual parameter of the nearest-neighbor pixel bears said predetermined relationship with that of the preceding pixel; and
(d) repeating step (c) until no further nearest-neighbor pixels meet both conditions (I) and (II).

19. The method as claimed in claim 18, wherein, if both conditions (I) and (II) are met by more than one of the nearest-neighbor pixels, then the said next pixel is selected in dependence on the shape of the part of the current scan path so far determined.

20. The method as claimed in claim 16, wherein the visual parameter comprises color.

21. The method as claimed in claim 16, wherein the position of the first end of each scan path is encoded as the number of pixels along a raster scan from the previous first end of another scan path.

22. The method as claimed in claim 16, wherein the shape of the scan path is encoded as a sequence of vectors, each vector within the sequence comprising a direction indicator and a length indicator.

23. The method as claimed in claim 16, wherein the value of the visual parameter of each pixel is encoded in accordance with a table in which a plurality of values of the visual parameter are stored at respective addresses, the visual parameter being encoded, in the case where its value is already stored in the table, by the address within the table at which the value is stored and, in the case where its value is not already stored in the table, by the value itself.

24. The method as claimed in claim 23, wherein, in the case where the value of the visual parameter is not already stored in the table, the value is written into the table at an address derived from a hash function of the value.

25. The method as claimed in claim 16, wherein each of the encoded scan paths terminates with a termination marker.

26. The method as claimed in claim 16, wherein the image comprises a third image which represents the difference between a first and a second image, each pixel of the third image being an Exclusive OR combination of the corresponding pixels of the first and second image.

27. The method as claimed in claim 26, further comprising the steps of transmitting an image sequence comprising the first image of the sequence encoded as a bit map and the third image.

28. The method as claimed in claim 27, further comprising the steps of:
(a) receiving the transmitted image sequence;
(b) decoding the first image from the bit map;
(c) decoding the third image and
(d) combining the third image with the first image thereby to recreate the second image.
